(19) United States
(12) Patent Application Publication
(10) Pub. No.: US 2012/0043803 A1
(43) Pub. Date: Feb. 23, 2012

(54) HUB COVER ATTACHMENT ASSEMBLY

(76) Inventors: Paul Grill, Lansing, MI (US); Garry Van Houten, Middleville, MI (US)

(21) Appl. No.: 12/860,950

(22) Filed: Aug. 23, 2010

(51) Int. Cl. B60B 7/04; B23P 11/00; B60B 7/06

(52) U.S. Cl. 301/37.26; 29/428; 29/525.01

(57) ABSTRACT

A hub cover attachment assembly having a bracket assembly detachably connected to an axle hub. A wheel cover is adjacent the bracket assembly. A washer plate operably connects the wheel cover to the bracket assembly and detachably couples with an emblem assembly disposed in the wheel cover.

### BACKGROUND OF THE INVENTION

The present invention relates to a hub cover attachment assembly, and in particular to a hub cover attachment assembly that includes a washer plate that operably connects a wheel cover to a bracket assembly while simultaneously coupling with an emblem assembly juxtaposed in the wheel cover.

### SUMMARY OF THE INVENTION

One aspect of the present invention is to provide a hub cover attachment assembly having a bracket assembly detachably connected to an axle hub. A wheel cover is adjacent the bracket assembly. A washer plate operably connects the wheel cover to the bracket assembly and detachably couples with an emblem assembly disposed in the wheel cover.

Another aspect of the present invention is to provide a hub cover attachment assembly having a bracket assembly detachably connected to an axle hub. A washer plate is operably connected to the bracket assembly. A wheel cover is at least partially disposed between the bracket assembly and the washer plate, and covers a portion of the bracket assembly from view. An emblem assembly is disposed over and detachably coupled with the washer plate.

Another aspect of the present invention is to provide a method of attaching a hub cover assembly including detachably connecting a bracket assembly to an axle hub. A washer plate is operably connected to the bracket assembly. A wheel cover is positioned at least partially between the bracket assembly and the washer plate. The bracket assembly is covered with the wheel cover. An emblem assembly is detachably coupled with the washer plate.

The present inventive wheel assembly is durable, provides a low manufacturing cost, includes an uncomplicated design, may be assembled with basic tools, and can be easily and quickly assembled by even relatively unskilled operators. The wheel assembly is capable of a long operating life, and is particularly well adapted for the proposed use, specifically for providing an outer drive axle dually-wheel type assembly or super-single drive axle wheel assembly with an aesthetic look similar to that typically associated with stylized wheels for standard passenger-type vehicles, and provides styling flexibility for such applications. Further, the wheel assembly may be personalized to display particular images, such as company names and logos, operator chosen symbols and the like, and may include a variety of metallic finishes, paint finishes, or combinations thereof.

These and advantages of the invention will be further understood and appreciated by those skilled in the art by reference to the following written specification, claims, and appended drawings.

### BRIEF DESCRIPTION OF THE DRAWINGS

FIG. 1 is a top perspective view of one embodiment of the vehicle wheel assembly of the present invention;

FIG. 2 is a top perspective view of one embodiment of the hub cover attachment assembly of the present invention; and

FIG. 3 is a bottom perspective view of one embodiment of the hub cover attachment assembly of the present invention.

### DETAILED DESCRIPTION OF EMBODIMENTS

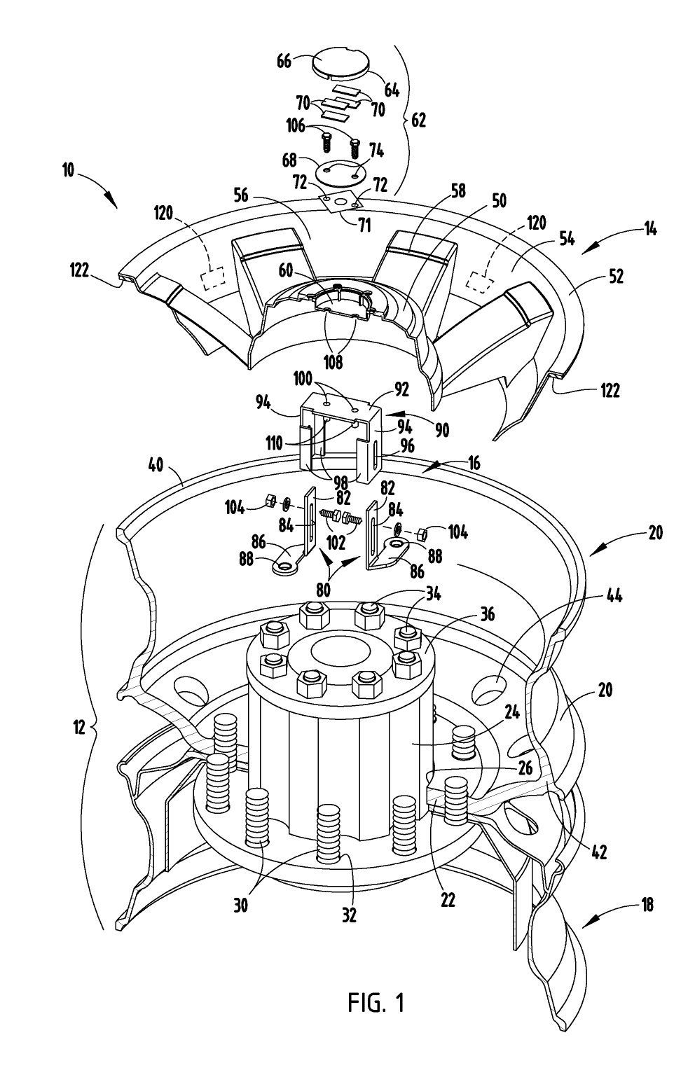

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, the reference numeral 10 generally designates a vehicle wheel assembly embodying the present invention. In the illustrated example, the wheel assembly 10 includes a vehicle wheel 12 and a wheel cover 14 attached to the vehicle wheel 12 via a wheel cover bracket assembly 16. The wheel assembly 10 forms a dually-wheel assembly having an outer wheel 20 adjacent to an inner wheel 18, in an arrangement typically applicable to light, medium, and heavy duty vehicles (i.e., pickup trucks, vans, buses, heavy duty trucks and trailers, recreational vehicles, motor homes, etc.), and in particular, vehicles within commercial vehicle weight classifications 1-8, as established by the U.S. Department of Transportation Federal Highway Administration, which utilizes dually-wheel configurations.

Referring again to FIG. 1, a central hub portion 22 of the outer wheel 20 is placed over a vehicle axle hub 24 such that the vehicle axle hub 24 extends through a central aperture 26 of the central hub portion 22. The central hub portion 22 is surrounded by multiple, equidistantly spaced lug bolts 30 spaced circumferentially about the central aperture 26. The lug bolts 30 are received within corresponding lug bolt apertures 32 located within the central hub portion 22 of the vehicle wheel 12. A plurality of hub axle studs 34 extend axially outward from an end 36 of the vehicle axle hub 24, and are equidistantly spaced in a circular pattern about the circumference thereof. The vehicle wheel 12 further includes an outer rim 40 extending circumferentially about the vehicle wheel 12, and a web portion 42 extending between the central hub portion 22. In the illustrated example, the web portion 42 includes a plurality of apertures 44 extending therethrough, for drainage, weight reduction and/or aesthetic purposes. The vehicle wheel 12 is comprised of steel, aluminum, or an alloy adequate for construction of the same.

The wheel cover 14 includes a central portion 50, an outer rim portion 52 circumscribing the wheel cover 14, and a web portion 54 extending between the central portion 50 and the outer rim portion 52 of the wheel cover 14. The central portion 50, the outer rim portion 52, and the web portion 54 of the wheel cover 14 include a single-integral piece that cooperates to form an outer surface of the wheel cover 14. An inner surface of the wheel cover 14 may include a glossy black finish material resistant to chrome plating, thereby reducing the costs associated with plating the wheel cover 14 and resulting in an inner surface that is more resistant to corrosion. In the illustrated example, the web portion 54 includes a plurality of turbine openings 56 and radially-extending supports 58 spaced equidistantly and circumferentially about the web portion 54. This construction provides an aesthetic appearance similar to those typically associated with wheel assemblies for passenger vehicles. It is noted that the wheel cover 14 may include numerous styling configurations and geometries typically used in stylized automotive and light truck wheels.

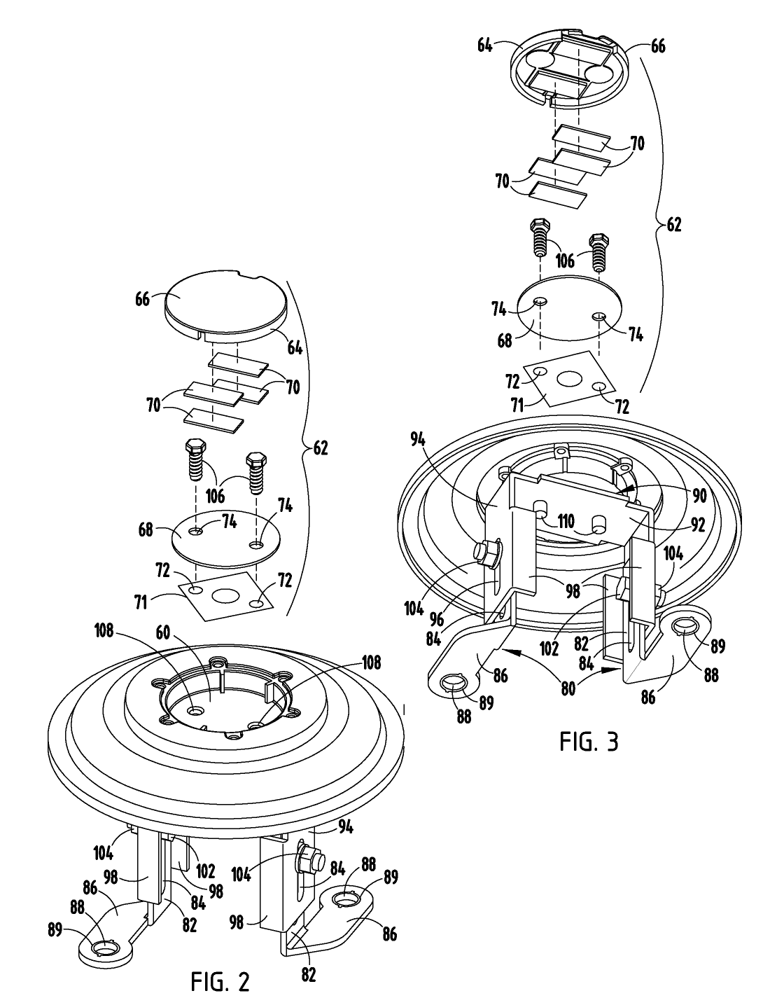

Referring now to FIGS. 2 and 3, the central portion 50 of the wheel cover 14 includes an axially inwardly-extending recess 60 adapted to receive a hub cover attachment assembly 62 having a cap 64, such as an emblem cap, therein. The cap 64 is covered by a decorative lens 66 that adds to the aesthetics. The cap 64 is connected to a washer plate 68 by a plurality of dual lock material members 70 having a hook and loop type construction and held in place by a two-way adhesive backing strip 71 (FIG. 1). The two-way adhesive backing strip 71 includes apertures 72 designed to align with apertures 74 on the washer plate 68. The apertures 72, 74 are designed to receive mechanical fasteners, as outlined in further detail below. The cap 64 and washer plate 68 are disposed in the axially inwardly-extending recess 60. The decorative lens 66 is provided with a logo, indicia, emblem, or other symbol or verbiage designed for that particular application.

Referring again to the embodiment illustrated in FIGS. 1 and 2, the bracket assembly 16 connects with the axle hub 24 and includes a pair of L-shaped brackets 80 each including a body portion 82 having an elongated slot 84, and a securing portion 86 extending orthogonally from the body portion 82 and including an aperture 88 extending therethrough. The aperture 88 includes a knockout 89 designed to accommodate various-sized hub axle studs 34. The bracket assembly 16 also includes a U-shaped bracket 90 including a support section 92, and a pair of attachment legs 94 that extend orthogonally from the support section 92. Each of the attachment legs 94 includes an elongated slot 96, and a pair of guide walls 98 extending longitudinally therealong. The support section 92 includes a pair of bolt-receiving apertures 100 extending therethrough, as discussed below.

In assembly, each of the L-shaped brackets 80 are secured to associated hub axle studs 34 by jam nuts 82, such that the securing portion 86 of each L-shaped bracket 80 is located between adjacent hub axle studs 34. A pair of lock bolts 102 extend through the slots 84, 96 of brackets 80, 90 and engage threaded fasteners 104, thereby allowing the U-shaped bracket 90 to be secured at various positions relative to the L-shaped brackets 80. A pair of wheel cover mounting studs 106 are located within the recess 60 of the wheel cover 14, extend through apertures 108 located within the recess 60 and through the apertures 100 of the U-shaped bracket 90, and are held in place by associated cinch nuts 110, thereby securing the wheel cover 14 to the bracket assembly 16, and consequently, the vehicle wheel assembly 10.

The linear adjustability between the second bracket 90 and the first brackets 80 allows the bracket assembly 16 to be utilized to secure wheel covers 14 of various shapes, sizes and depths to the associated vehicle and vehicle wheel, and to account for axial stack-up tolerance variations from axle hub components, wheel components, bracket components and the like. Specifically, the bracket assembly 16 allows adjustment such that the outer rim portion 52 of the wheel cover 14 aligns with the outer rim 40 of the vehicle wheel 12, and as a result, provides a recessed style outer dually-wheel with a relatively more shallow aesthetic appearance, such as those associated with single-wheel applications utilized on typical passenger vehicles. More specifically, the rim outer portions 52 of the wheel cover 14 align with the outer rim 40 of the vehicle wheel 12, such that the combination of the vehicle wheel 12 and the wheel cover 14 provide an aesthetic appearance of a single-piece wheel construction, e.g., cast aluminum or forged wheels. It is noted that the bridging of the wheel cover 14 area across substantially the entire outer visible surface of the vehicle wheel 12, including a wheel rim balance weight flange area, provides a full-surface appearance typically associated with single wheel assemblies with high offsets and aerodynamic characteristics.

Referring again to FIG. 1, a plurality of cushioning members including foam pads 120 and a foam rim insert 122 are shown in the illustrated embodiment and help seat the wheel cover 14 on the outer wheel 20. The foam pads 120 may be positioned between the web portion 54 of the wheel cover 14 and the web portion 54 of the vehicle wheel 12 and provide proper radial alignment of the wheel cover 14 with respect to the vehicle wheel 12, and further cooperate with the bracket assembly 16 to provide radial uniformity of the wheel cover 14 and the vehicle wheel 12. The foam pads 120 also reduce vibrations transmitted from the vehicle wheel 12 to the wheel cladding and the vibratory noise associated therewith. A foam rim insert 122 may also be included that circumferentially extends about the wheel cover 14 and is positioned between the outer rim portion 52 of the wheel cover 14 and the outer rim 40 of the vehicle wheel 12. The foam rim insert 122 reduces frictional noise and protects the wheel cover 14 from damage caused by frictional contact between the wheel cover 14 and the vehicle wheel 12. The cap 64 is then secured radially outboard of the recess 60, thereby covering the bolts 106 and providing an aesthetic customization to the vehicle wheel assembly 10, and further providing a degree of theft deterrence.

The present inventive hub cover attachment assembly 12 provides a cost effective alternative attachment design for connecting the wheel cover 14 to the vehicle wheel 12. Specifically, the bracket assembly 16 detachably connects to the end 36 of the vehicle axle hub 24. The wheel cover mounting studs 106 extend through the apertures 74 of the washer plate 68 and operably connect the wheel cover 14 to the bracket assembly 16. The cap 66 is detachably coupled with the washer plate 68. Accordingly, the washer plate 68 provides two functions. Specifically, the washer plate 68 distributes the attachment bolt forces that connect the wheel cover 14 to the bracket assembly 16 and also secures the emblem cap assembly on the wheel cover 14. In the event, a user wishes to change the wheel cover 14, the emblem cap assembly is simply removed from the washer plate 68 and mechanical fasteners that extend through the washer plate 68 are removed to thus remove the wheel cover 14. This alternative design is capable of long use, while providing an aesthetically pleasing wheel cover 14 on a large dually-wheel type vehicle.

Additionally, the present inventive vehicle wheel assembly 10 is durable, provides a low manufacturing cost, includes an uncomplicated design, may be assembled with basic tools, and can be easily and quickly assembled, installed and/or removed by even relatively unskilled operators, thereby allowing for wheel and tire maintenance, and inspections in minimal time. The vehicle wheel assembly 10 is capable of a long operating life, and is particularly well adapted for the proposed use, specifically for providing a dually-wheel type assembly with an aesthetic look similar to that typically associated with single-wheel assemblies for standard passenger-type vehicles. Further, the vehicle wheel assembly 10 may be personalized to display particular images, such as company names and logos, operator chosen symbols and the like.

In the foregoing description, it will be readily appreciated by those skilled in the art that modifications may be made to the invention without departing from the concepts disclosed herein. Such modifications are to be considered as included in the following claims, unless these claims by their language expressly state otherwise.

What is claimed is:

1. A hub cover attachment assembly comprising:
a bracket assembly detachably connected to an axle hub;
a wheel cover adjacent the bracket assembly; and
a washer plate that operably connects the wheel cover to the bracket assembly and detachably couples with an emblem assembly disposed in the wheel cover.

2. The hub cover attachment assembly of claim 1, further comprising:
a hook and loop fastening member disposed between the emblem assembly and the washer plate.

3. The hub cover attachment assembly of claim 1, wherein the bracket assembly includes first and second elongate members that are linearly adjustable.

4. The hub cover attachment assembly of claim 1, wherein the washer plate includes apertures adapted to receive mechanical fasteners that detachably couple the washer plate to the bracket assembly.

5. The hub cover attachment assembly of claim 1, wherein the wheel cover includes a recess adapted to receive the washer plate and at least a portion of the emblem assembly.

6. The hub cover attachment assembly of claim 1, wherein the bracket assembly includes apertures that receive mechanical fasteners that secure the bracket assembly to the axle hub, and wherein the apertures include knockouts such that the apertures can accommodate axle cover mechanical fasteners of different sizes.

7. The hub cover attachment assembly of claim 1, wherein the emblem assembly includes a center cap with a protective cover lens.

8. A hub cover attachment assembly comprising:
a bracket assembly detachably connected to an axle hub;
a washer plate operably connected to the bracket assembly;
a wheel cover at least partially disposed between the bracket assembly and the washer plate, and covering a portion of the bracket assembly from view; and
an emblem assembly disposed over and detachably coupled with the washer plate.

9. The hub cover attachment assembly of claim 8, further comprising:
a hook and loop fastening member disposed between the emblem assembly and the washer plate.

10. The hub cover attachment assembly of claim 8, wherein the bracket assembly includes first and second elongate members that are linearly adjustable.

11. The hub cover attachment assembly of claim 8, wherein the washer plate includes apertures adapted to receive mechanical fasteners that detachably couple the washer plate to the bracket assembly.

12. The hub cover attachment assembly of claim 8, wherein the wheel cover includes a recess adapted to receive the washer plate and at least a portion of the emblem assembly.

13. The hub cover attachment assembly of claim 12, further comprising:
an adhesive backing material that secures the washer plate in place in the recess.

14. The hub cover attachment assembly of claim 8, wherein the emblem assembly includes a center cap with a protective cover lens.

15. A method of attaching a hub cover assembly comprising:
detachably connecting a bracket assembly to an axle hub;
operably connecting a washer plate to the bracket assembly;
positioning a wheel cover at least partially between the bracket assembly and the washer plate;
covering the bracket assembly with the wheel cover; and
detachably coupling an emblem assembly with the washer plate.

16. The method of claim 15, further comprising:
forming a recess in the wheel cover that receives the washer plate.

17. The method of claim 16, further comprising:
securing the washer plate in the recess with an adhesive backing material.

18. The method of claim 15, further comprising:
providing an emblem assembly with a center cap and a protective cover lens.

19. The method of claim 15, wherein the step of detachably coupling the emblem assembly, further comprises:
providing a hook and loop fastening member that detachably couples the emblem assembly in the recess.

20. The method of claim 15, further comprising:
applying foam cushioning members to the wheel cover that are adapted to abut a wheel connected with the axle hub.
